(19) United States
(12) Patent Application Publication
(10) Pub. No.: US 2025/0182454 A1
(43) Pub. Date: Jun. 5, 2025

(54) OBJECT DETECTION APPARATUS AND A DATA AUGMENTATION METHOD THEREOF

(71) Applicants: HYUNDAI MOTOR COMPANY, Seoul (KR); KIA CORPORATION, Seoul (KR)

(72) Inventors: Yo Han Sung, Hwaseong-si (KR); Ju Heon Baeg, Hwaseong-si (KR)

(73) Assignees: HYUNDAI MOTOR COMPANY, Seoul (KR); KIA CORPORATION, Seoul (KR)

(21) Appl. No.: 18/913,237

(22) Filed: Oct. 11, 2024

(30) Foreign Application Priority Data
Dec. 5, 2023 (KR) 10-2023-0174551

(51) Int. Cl. G06V 10/774; G06T 3/20; G06V 10/26; G06V 10/82

(52) U.S. Cl. CPC G06V 10/774; G06T 3/20; G06V 10/26; G06V 10/82

(57) ABSTRACT

An object detection apparatus obtains point cloud data. The object detection apparatus selects a source object and a target object based on characteristics of multiple objects included in the point cloud data and geometry information between the multiple objects. The object detection apparatus selects a target partition to apply data augmentation based on geometry information between the source object and the target object. The object detection apparatus performs data augmentation of the point cloud data by applying an augmentation technique to the selected target partition, and outputs the augmented point cloud data.

### CROSS-REFERENCE TO RELATED APPLICATION

This application claims the benefit of and priority to Korean Patent Application No. 10-2023-0174551, filed on Dec. 5, 2023, the entire contents of which are hereby incorporated herein by reference.

### TECHNICAL FIELD

The present disclosure relates to an object detection apparatus and a data augmentation method thereof.

### BACKGROUND

A three-dimensional (3D) object detection device may simultaneously estimate bounding box information (e.g., a position (x, y, z), a size (width, length, height), and a heading angle) and a class of an object from a light detection and ranging (LiDAR) point cloud by means of a deep learning-based detection network. The 3D object detection device may train the detection network to improve the performance of the detection network. A labeled bounding box and class ground-truth (GT) are used to train the detection network. Furthermore, a data augmentation technology may be applied to improve the performance of training the detection network.

The data augmentation technology is a technique for applying various conversions to original data to increase the amount of data. The data augmentation technology may include a global-augmentation technology, an object-augmentation technology, or the like. It is impossible for the global-augmentation technology to process data for each object and/or each class, because of using an augmentation technique of rotating, reversing, or zooming in or out on a scene. It is possible for the object-augmentation technology to process data for each object or each class.

An existing object-augmentation technology performs probabilistic random augmentation for all objects without considering characteristics of objects. In other words, the existing object-augmentation technology randomly and probabilistically selects which object to perform augmentation on and how much intensity to apply. Thus, when data is augmented, a side effect situation in which data quality is not improved and deteriorates occurs. For example, when high-occlusion occurs for many areas of an object due to an obstacle or a preceding vehicle, data quality deteriorates compared to the original although augmenting original data of the object.

### SUMMARY

The present disclosure has been made to solve the above-mentioned problems occurring in the prior art while advantages achieved by the prior art are maintained intact.

Aspects of the present disclosure provide an object detection apparatus for performing attribute-aware data augmentation with regard to characteristics of multiple objects and geometry information between the multiple objects and a data augmentation method thereof.

Other aspects of the present disclosure provide an object detection apparatus for adaptively adjusting an object to apply data augmentation and application intensity based on an attribute of an object and performing efficient data augmentation suitable for an object and dataset situation and a data augmentation method thereof.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an object detection apparatus is provided. The object detection apparatus includes a processor configured to obtain point cloud data. The processor is also configured to select a source object and a target object based on characteristics of multiple objects included in the point cloud data and geometry information between the multiple objects. The processor is further configured to select a target partition to apply data augmentation based on geometry information between the source object and the target object. The processor is further still configured to perform data augmentation of the point cloud data by applying an augmentation technique to the target partition to generate augmented point cloud data. The processor is additionally configured to output the augmented point cloud data.

The processor may be configured to select the source object and the target object based on occlusion attributes of the multiple objects. The processor may also be configured to determine effectiveness of selecting the source object and the target object based on the geometry information between the source object and the target object.

The processor may be configured to determine that it is valid to select the source object and the target object, when the source object and the target object are located in a same quadrant with respect to a vehicle and there are a heading of the source object and a heading of the target object at a same quadrantal angle.

The processor may be configured to segment each of the source object and the target object into a plurality of segmented partitions. The processor may also be configured to extract foreground-partitions of the source object among the segmented partitions of the source object. The processor may further be configured to randomly select a foreground-partition from among the foreground-partitions. The processor may additionally be configured to determine whether there is a point in a partition of the target object, the partition corresponding to the foreground-partition. The processor may also be configured to determine that it is valid to select the foreground-partition, based on determining that there is the point in the partition of the target object.

The processor may be configured to select a vertex closest to a vehicle among four vertices on a top view of the source object. The processor may further be configured to select an edge touching the selected vertex. The processor may be additionally configured to select at least one partition associated with the selected edge as a candidate foreground-partition.

The processor may be configured to translate the source object and the target object to an origin. The processor may also be configured to determine data augmentation intensity based on occlusion attributes of the source object and the target object. The processor may further be configured to apply a first augmentation technique based on the data augmentation intensity to perform the data augmentation. The processor may also be configured to retranslate the source object and the target object augmented by the first augmentation technique to original positions. The processor may further be configured to apply a second augmentation technique based on the data augmentation intensity to perform the data augmentation. The processor may additionally be configured to retranslate the source object and the target object augmented by the second augmentation technique to the original positions.

The first augmentation technique may be a swap technique for swapping a point in a randomly selected partition of the source object for a point in a partition of the target object, the partition corresponding to the randomly selected partition.

The second augmentation technique may be a mix technique for copying and pasting a point in a randomly selected partition of the source object into a partition of the target object, the partition corresponding to the randomly selected partition.

The processor may be configured to determine the data augmentation intensity based on a difference in occlusion degree between the source object and the target object.

The processor may be configured to train an object detection model using the augmented point cloud data.

According to another aspect of the present disclosure, a data augmentation method of an object detection apparatus is provided. The data augmentation method includes obtaining point cloud data, and selecting a source object and a target object based on characteristics of multiple objects included in the point cloud data and geometry information between the multiple objects. The data augmentation method also includes selecting a target partition to apply data augmentation based on geometry information between the source object and the target object. The data augmentation method additionally includes performing data augmentation of the point cloud data by applying an augmentation technique to the selected target partition to generate augmented point cloud data. The data augmentation method further includes outputting the augmented point cloud data.

Selecting the source object and the target object may include selecting the source object and the target object with regard to occlusion attributes of the multiple objects. Selecting the source object and the target object may also include determining effectiveness of selecting the source object and the target object based on the geometry information between the source object and the target object.

Determining the effectiveness may include determining that it is valid to select the source object and the target object when the source object and the target object are located in a same quadrant with respect to a vehicle and there are a heading of the source object and a heading of the target object at a same quadrantal angle.

Selecting the target partition may include segmenting each of the source object and the target object into a plurality of segmented partitions. Selecting the target partition may also include extracting foreground-partitions of the source object among the segmented partitions of the source object. Selecting the target partition may additionally include randomly selecting a foreground-partition from among the foreground-partitions. Selecting the target partition may further include determining whether there is a point in a partition of the target object, the partition corresponding to the foreground-partition. Selecting the target partition may further still include determining that it is valid to select the foreground-partition, based on determining that there is the point in the partition of the target object.

Extracting the foreground-partitions may include selecting a vertex closest to a vehicle among four vertices on a top view of the source object. Extracting the foreground-partitions may also include selecting an edge touching the selected vertex. Extracting the foreground-partitions may additionally include selecting at least one partition associated with the selected edge as a candidate foreground-partition.

Performing the data augmentation may include translating the source object and the target object to an origin. Performing the data augmentation may also include determining data augmentation intensity based on occlusion attributes of the source object and the target object. Performing the data augmentation may additionally include applying a first augmentation technique based on the data augmentation intensity to perform the data augmentation. Performing the data augmentation may further include retranslating the source object and the target object augmented by the first augmentation technique to original positions. Performing the data augmentation may further still include applying a second augmentation technique based on the data augmentation intensity to perform the data augmentation. Performing the data augmentation may also include retranslating the source object and the target object augmented by the second augmentation technique to the original positions.

Applying the first augmentation technique to perform the data augmentation may include swapping a point in a randomly selected partition of the source object for a point in a partition of the target object, the partition corresponding to the randomly selected partition.

Applying the second augmentation technique to perform the data augmentation may include copying and pasting a point in a randomly selected partition of the source object into a partition of the target object, the partition corresponding to the randomly selected partition.

Determining the data augmentation intensity may include determining the data augmentation intensity based on a difference in occlusion degree between the source object and the target data. The data augmentation method may further include training an object detection model using the augmented point cloud data.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of an object detection, apparatus according to embodiments of the present disclosure;

FIG. 2 is a flowchart illustrating a method for training an object detection network, according to embodiments of the present disclosure;

FIG. 3 is a flowchart illustrating a data augmentation method, according to embodiments of the present disclosure;

FIG. 4 is a flowchart illustrating a method for selecting a source object and a target object shown in FIG. 3, according to embodiments of the present disclosure;

FIG. 5 is drawing for describing an occlusion attribute, according to embodiments of the present disclosure;

FIG. 6 is a drawing for describing a quadrant, according to embodiments of the present disclosure;

FIG. 7 is a drawing illustrating an example of determining effectiveness of selecting a source object and a target object, according to embodiments of the present disclosure;

FIG. 8 is a flowchart illustrating a method for selecting an augmentation application target partition shown in FIG. 3, according to embodiments of the present disclosure;

FIG. 9 is a drawing illustrating an example of object partition, according to embodiments of the present disclosure;

FIGS. 10A and 10B are drawings illustrating an example of selecting augmentation application target partition, according to embodiments of the present disclosure;

FIG. 11 is a drawing illustrating an example of selecting a partition of a target object, according to embodiments of the present disclosure;

FIG. 12 is a flowchart illustrating a method for performing data augmentation shown in FIG. 3, according to embodiments of the present disclosure;

FIG. 13A is drawing for describing a swap technique, according to embodiments of the present disclosure;

FIG. 13B is drawing for describing a mix technique, according to embodiments of the present disclosure;

FIG. 14 is drawing for describing object retranslation, according to embodiments of the present disclosure;

FIG. 15 is a drawing illustrating data before and after augmentation, according to embodiments of the present disclosure; and

FIG. 16 is a block diagram illustrating a computing system for executing a data augmentation method, according to embodiments of the present disclosure.

### DETAILED DESCRIPTION

Hereinafter, embodiments of the present disclosure are described in detail with reference to the accompanying drawings. In adding the reference numerals to the components of the accompanying drawings, it should be noted that the identical components are designated by the identical numerals even when the components are displayed on different drawings. In addition, a detailed description of well-known features or functions has been omitted where it was determined that the detailed description would unnecessarily obscure the gist of the present disclosure.

In describing components of embodiments of the present disclosure, the terms first, second, A, B, (a), (b), and the like may be used herein. These terms are only used to distinguish one component from another component. The terms do not limit the corresponding components irrespective of the order or priority of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equal to the contextual meanings in the relevant field of art. The terms should not be interpreted as having ideal or excessively formal meanings unless clearly defined as having such in the present disclosure.

When a component, device, element, or the like of the present disclosure is described as having a purpose or performing an operation, function, or the like, the component, device, or element should be considered herein as being “configured to” meet that purpose or perform that operation or function.

A multi-object-based attribute-aware data augmentation technology for performing data augmentation with regard to position information between multiple objects and characteristics of objects upon data augmentation for improving object detection learning performance is disclosed in the specification.

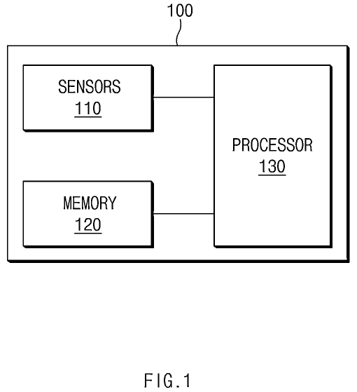

FIG. 1 is a block diagram illustrating a configuration of an object detection apparatus, according to embodiments of the present disclosure.

An object detection apparatus 100 may be mounted on a vehicle to detect three-dimensional (3D) information (or 3D object information) for an object (e.g., a pedestrian, a vehicle, a bus, a truck, and/or the like) around the vehicle. Referring to FIG. 1, the object detection apparatus 100 may include sensors 110, a memory 120, a processor 130, and the like.

The sensors 110 may obtain object information. The object information may be point cloud scene data (or point cloud data) having a labeled bounding box (or object) or the like. The sensors 110 may obtain a point cloud using a light detection and ranging (LiDAR) sensor or the like. The LiDAR sensor may radiate a laser pulse and may measure an arrival time of the laser pulse reflected from an object, thus calculating space position coordinates (or point information) at a reflection point.

The memory 120 may store a dataset including training data. The training data may include ground truth (GT) data that is experimental information about an object. The memory 120 may store an object detection model (or an object detection network) that is a training target. The memory 120 may store a training model to which a deep learning network is applied. Furthermore, the memory 120 may store a data augmentation algorithm (or a data augmentation model).

The memory 120 may store the information (e.g., the point cloud data) obtained by the sensors 110. Furthermore, the memory 120 may store preset information and input data and/or output data of the processor 130.

The memory 120 may be a non-transitory storage medium that stores instructions executed by the processor 130. The memory 120 is illustrated in FIG. 1 as being located outside the processor 130. However, the present disclosure is not limited thereto. For example, the memory 120 may be located inside the processor 130. The memory 120 may include at least one of storage media such as a flash memory, a hard disk, a solid state disk (SSD), universal flash storage (UFS), a random access memory (RAM), a static RAM (SRAM), a read only memory (ROM), a programmable ROM (PROM), an electrically erasable and programmable ROM (EEPROM), or an erasable and programmable ROM (EPROM).

The processor 130 may include at least one processing device such as an application specific integrated circuit (ASIC), a digital signal processor (DSP), programmable logic devices (PLD), a field programmable gate array (FPGA), a central processing unit (CPU), a microcontroller, and/or a microprocessor.

The processor 130 may receive point cloud data. The processor 130 may apply an augmentation technique based on geometry information between multiple objects included in the point cloud data and characteristics of the multiple objects to perform data augmentation. The augmentation technique may include one or more techniques such as a swap technique and/or a mix technique. The swap technique may be an augmentation technology for selecting two objects, e.g., a source object and a target object, and partially swapping points configured between the selected objects. The mix technique may be an augmentation technology for selecting a source object and a target object and copying and pasting some points of the source object into the target object.

The processor 130 may output point cloud data augmented based on the characteristics of the multiple objects and the geometry information between the multiple objects. The processor 130 may store the augmented point cloud data in the memory 120. The processor 130 may train the object detection model using the augmented data as training data.

Hereinafter, a description is given in detail of a process of performing a data augmentation function in the processor 130, according to embodiments of the present disclosure.

The processor 130 may select a source object and a target object among objects included in the received point cloud data. The processor 130 may determine the source object and the target object based on occlusion attribute information of the objects and geometry information between the objects. For example, the processor 130 may select an object with less occlusion and higher point density as the source object. Furthermore, the processor 130 may select two objects that have a similar point pattern in a scene as the source object and the target object, based on the geometry information to reduce a sense of difference when swapping points.

The processor 130 may select an augmentation application target partition using local features of the source object and the target object. The processor 130 may segment each of the selected source object and the selected target object into a plurality of partitions. The processor 130 may select a target partition to perform (or apply) data augmentation using a characteristic for each segmented partition.

The processor 130 may select the source object and the target object among the objects included in the point cloud data based on occlusion attributes of the objects included in the point cloud data. The occlusion attribute may be information for identifying an occlusion degree of an object due to surrounding objects, which may be indicated as a flag according to the occlusion degree. When the occlusion degree is 0%, the flag may be set to “0”. When the occlusion degree is greater than 0% and is less than or equal to 50%, the flag may be set to “1”. When the occlusion degree is greater than 50%, the flag may be set to “2”. The processor 130 may select an object in which the flag of the occlusion attribute is set to “0” as the source object. The processor 130 may select an object in which the flag of the occlusion attribute is set to “1” or “2” as the target object.

The processor 130 may determine effectiveness for selecting the source object and the target object using geometry information between the source object and the target object. The processor 130 may use geometry information between objects, each of which has similar point distribution in the object, to select the objects as the source object and the target object. The processor 130 may identify whether there are a source object and a target object in a quadrant with respect to a vehicle (or an ego vehicle). The processor 130 may identify whether there are headings (or yaw angles) of the source object and the target object at the same quadrantal angle with respect to the center of the vehicle. The quadrant may refer to four portions divided by two coordinate axes that have the center of a front end of the vehicle as the origin. The quadrantal angle may divide a yaw angle section (or range) of the object into four sections, which may divide the yaw angle section (or range) into

$$0 \leq ∅ < \frac{π}{2} , \frac{π}{2} \leq ∅ < π , π \leq ∅ < \frac{3 π}{2} , and \frac{3 π}{2} \leq ∅ < 2 π .$$

When the source object and the target object are located in the same quadrant and the headings of the source object and the target object belong to the same quadrantal angle, the processor 130 may determine that it is valid to select the source object and the target object. On the other hand, when the source object and the target object are located in different quadrants or the headings of the source object and the target object belong to different quadrantal angles or when the source object and the target object are located in different quadrants and the headings of the source object and the target object belong to different quadrantal angles, the processor 130 may determine that it is not valid to select the source object and the target object.

The processor 130 may segment each of the source object and the target object into a plurality of partitions. The processor 130 may segment each of the objects included in the point cloud data into a plurality of partitions. The number of partitions and the partition segmentation scheme may be determined based on a type of the object and a characteristic of the object.

The processor 130 may select two sides that touch a vertex closest to the vehicle (0, 0) among vertices of a bounding box of the source object from a top view as foreground-sides. The processor 130 may select partitions associated with the sides as foreground-partitions (or candidate partitions) on a 3D view. The processor 130 may randomly select any one of the foreground-partitions.

The processor 130 may determine a partition of the target object that corresponds to the selected partition of the source object. The processor 130 may determine whether there is a point in the partition of the target object that corresponds to the selected partition of the source object. When it is determined that there is the point in the partition of the target object, the processor 130 may determine that it is valid to select the target partition. When it is determined that it is valid to select the target partition, the processor 130 may perform data augmentation for the selected partition of the source object and the partition of the target object that corresponds to the partition. When it is determined that there is no point in the partition of the target object, the processor 130 may determine that it is not valid to select the target partition. When it is determined that it is not valid to select the target partition, the processor 130 may select a target partition again.

The processor 130 may apply a probability-based augmentation technique to the selected target partition to perform data augmentation. The processor 130 may calculate a probability (or augmentation application intensity) to apply an augmentation technique based on the occlusion attributes of the objects (i.e., the source object and the target object). For example, the processor 130 may calculate a swap application probability and a mix application probability with regard to the occlusion degrees of the objects. The processor 130 may apply the augmentation technique based on the calculated probability to perform the data augmentation. The processor 130 may perform translation and retranslation for the bounding box and the point of the object and may apply the augmentation technique.

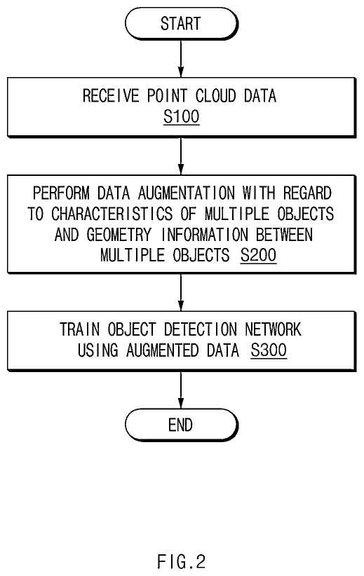

FIG. 2 is a flowchart illustrating a method for training an object detection network, according to embodiments of the present disclosure.

Referring to FIG. 2, in an operation S100, a processor (e.g., the processor 130) may receive point cloud data including label data. The processor 130 may receive point cloud data from sensors 110 or may read (or access) point cloud data from a memory 120. The point cloud data may include multiple objects.

In an operation S200, the processor 130 may perform data augmentation based on characteristics of the multiple objects and geometry information between the multiple objects. The processor 130 may apply a swap technique to swap geometry of some point of a source object for geometry of some point of a target object, thus augmenting data. Furthermore, the processor 130 may apply a mix technique to copy and paste some points of the source object into the target object, thus augmenting data.

In an operation S300, the processor 130 may train an object detection network using the augmented data. For example, the processor 130 may train the object detection model by using the augmented data as training data. When completing the training of pieces of all point cloud data of a dataset, the processor 130 may end the training.

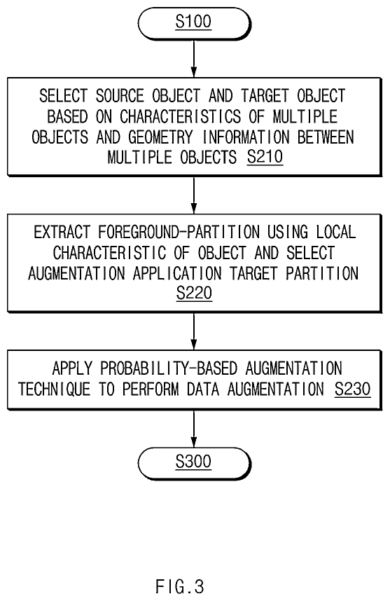

FIG. 3 is a flowchart illustrating a data augmentation method, according to embodiments of the present disclosure.

In an operation S210, a processor (e.g., the processor 130) may select a and a target object based on characteristics of multiple objects and geometry information between the multiple objects. The processor 130 may select the source object and the target object among objects included in received point cloud data. The processor 130 may determine the source object and the target object based on pieces of occlusion attribute information of the objects and geometry information between the objects. For example, the processor 130 may select an object with less occlusion and higher point density as the source object. Furthermore, the processor 130 may select two objects that have a similar point pattern in a scene as the source object and the target object, based on the geometry information to reduce a sense of difference when swapping points.

In an operation S220, the processor 130 may extract a foreground-partition using a local characteristic of the object and may select augmentation application target partition. The processor 130 may segment each of the selected source object and the selected target object into a plurality of partitions. The processor 130 may select a partition (or a target partition) to perform data augmentation using a characteristic for each segmented partition. For example, the processor 130 may determine a partition to perform data augmentation using geometry information of the object.

In an operation S230, the processor 130 may apply a probability-based augmentation technique to perform the data augmentation. The processor 130 may calculate a probability (or augmentation application intensity) to apply an augmentation technique based on occlusion attributes of objects (i.e., the source object and the target object). For example, the processor 130 may calculate a swap application probability and a mix application probability with regard to occlusion degrees of the objects. The processor 130 may apply the augmentation technique based on the calculated probability to perform the data augmentation. The processor 130 may perform translation and retranslation for a bounding box and a point of the object and may apply the augmentation technique.

The data augmentation method according to the above-mentioned embodiment may be applied in only the training stage and not applied in an inference stage on an application of the trained detection network model, thus improving the performance of detection accuracy without affecting a time when the object detection network is performed upon actual inference of the object detection network.

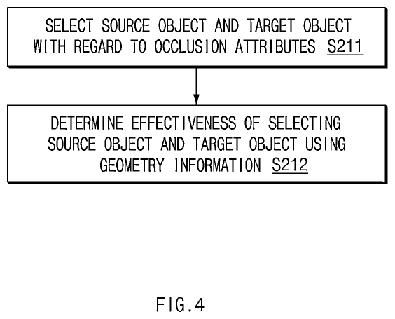

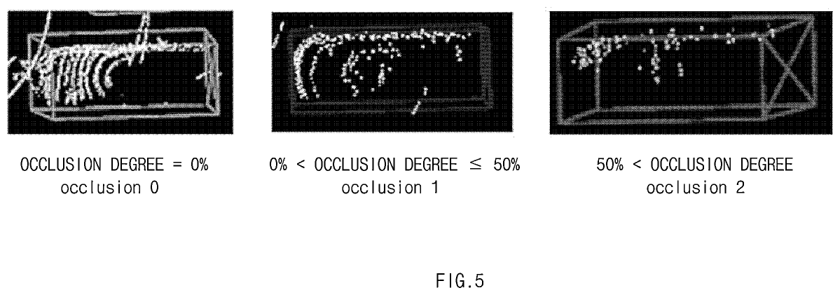

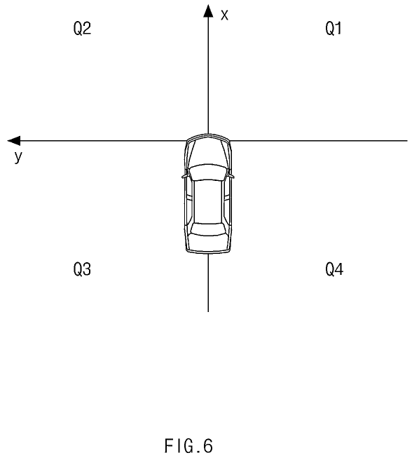

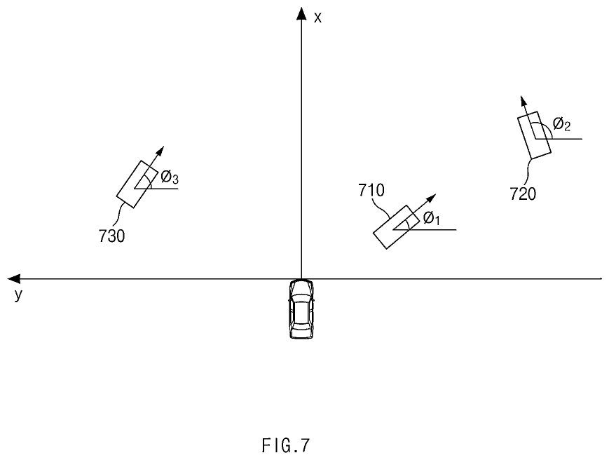

FIG. 4 is a flowchart illustrating a method for selecting a source object and a target object shown in FIG. 3, according to embodiments of the present disclosure. FIG. 5 is drawing for describing an occlusion attribute, according to embodiments of the present disclosure. FIG. 6 is a drawing for describing a quadrant, according to embodiments of the present disclosure. FIG. 7 is a drawing illustrating an example of determining effectiveness of selecting a source object and a target object, according to embodiments of the present disclosure.

Referring to FIG. 4, in an operation S211, a processor (e.g., the processor 130) may select a source object and a target object with regard to occlusion attributes of objects included in point cloud data. The occlusion attribute may be information for identifying an occlusion degree of an object due to surrounding objects, which may be indicated as a flag according to the occlusion degree. Referring to FIG. 5, when the occlusion degree is 0%, the flag of the occlusion attribute may be set to “0”. When the occlusion degree is greater than 0% and is less than or equal to 50%, the flag of the occlusion attribute may be set to “1”. When the occlusion degree is greater than 50%, the flag of the occlusion attribute may be set to “2”. The processor 130 may select an object, in which the flag of the occlusion attribute is set to “0”, as the source object and may select an object, in which the flag of the occlusion attribute is set to “1” or “2”, as the target object.

In an operation S212, the processor 130 may determine effectiveness of selecting the source object and the target object using geometry information between the source object and the target object. The processor 130 may use geometry information between objects, each of which has similar point distribution in the object, to select the objects as the source object and the target object. The processor 130 may identify whether there are a source object and a target object in a quadrant with respect to a vehicle. The processor 130 may identify whether headings (or yaw angles) of the source object and the target object belong to the same quadrantal angle with respect to the center of the vehicle. Referring to FIG. 6, the quadrant refers to four portions (or areas) divided by two coordinate axes which have the center of a front end of the vehicle as the origin. The quadrant may divide a yaw angle section (or range) of the object into four sections, which may divide the yaw angle section (or range) into

$$0 \leq ∅ < \frac{π}{2} , \frac{π}{2} \leq ∅ < π , π \leq ∅ < \frac{3 π}{2} , and \frac{3 π}{2} \leq ∅ < 2 π .$$

Referring to FIG. 7, a first object 710 and a second object 720 are located in a first quadrant with respect to a vehicle, and a third object 730 is present in a second quadrant. Furthermore, headings of the first object 710 and the second object 720 belong to the same quadrantal angle, and the headings of the first object 710 and the third object 730 belong to different quadrantal angles. In this case, the processor 130 may select the first object 710 and the second object 720, that are present in the same quadrant and belong to the same quadrantal angle, as a source object and a target object. In other words, when selecting the first object 710 and the second object 720 as the source object and the target object, the processor 130 may determine that it is valid to select the objects. On the other hand, when selecting the first object 710 and the third object 730 as the source object and the target object, the processor 130 may determine that it is not valid to select the objects. When it is determined that it is not valid to select the objects, the processor 130 may select a source object and a target object again.

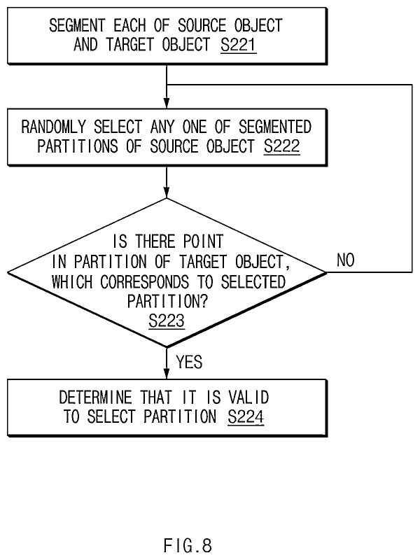

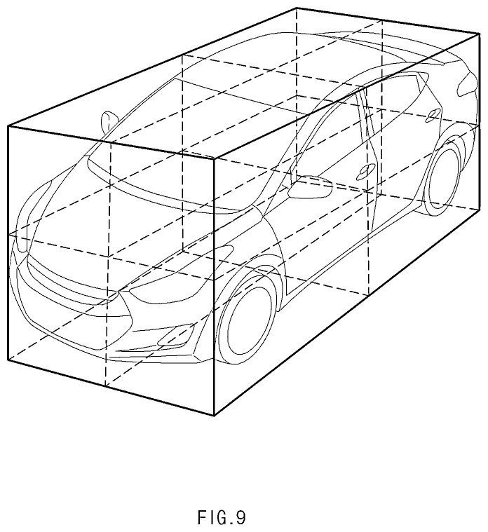

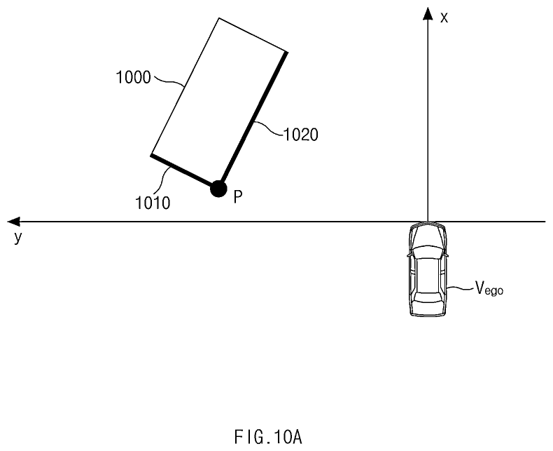

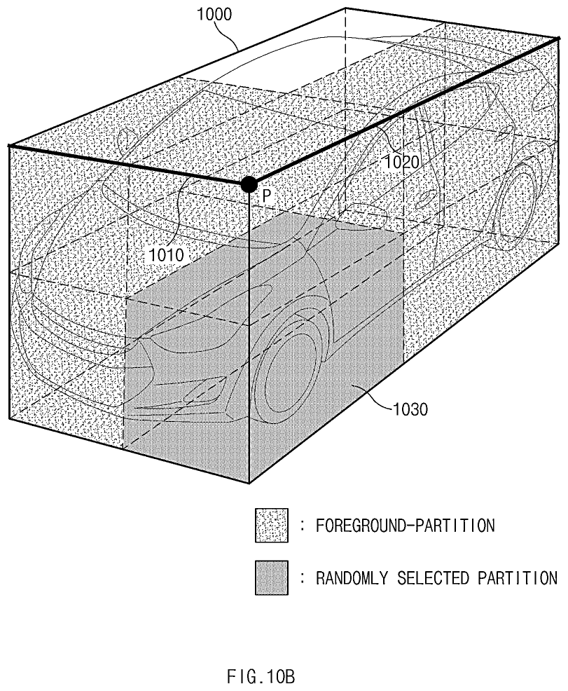

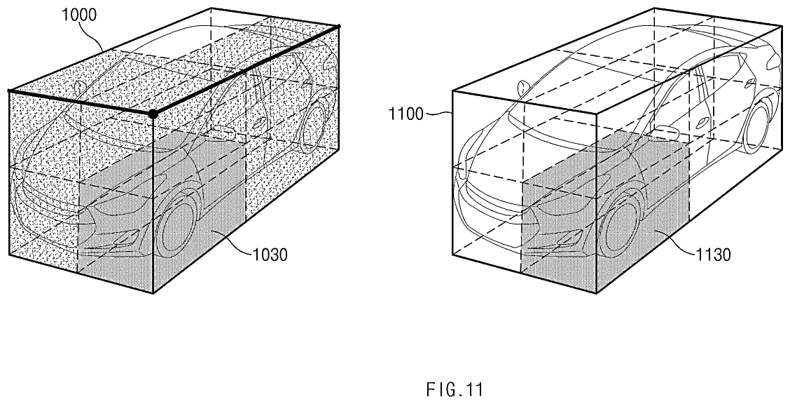

FIG. 8 is a flowchart illustrating a method for selecting an augmentation application target partition shown in FIG. 3, according to embodiments of the present disclosure. FIG. 9 is a drawing illustrating an example of object partition associated with embodiments of the present disclosure, according to embodiments of the present disclosure. FIGS. 10A and 10B are drawings illustrating an example of selecting augmentation application target partition associated with embodiments of the present disclosure, according to embodiments of the present disclosure. FIG. 11 is a drawing illustrating an example of selecting a partition of a target object. According to embodiments of the present disclosure.

Referring to FIG. 8, in an operation S221, a processor (e.g., the processor 130) may segment each of objects (i.e., a source object and a target object) into a plurality of partitions. The processor 130 may partition a bounding box of the object into a predetermined number. For example, as shown in FIG. 9, the processor 130 may segment a bounding box of a vehicle object into 8 partitions. The number of partitions and the partition segmentation scheme may be determined based on a type of the object and a characteristic of the object.

In an operation S222, the processor 130 may randomly select any one of the segmented partitions of the source object. The processor 130 may select a vertex closest to vehicle (0, 0) among four vertices of the bounding box of the source object from a top view. Further, the processor 130 may select a side, which touches the selected vertex, as a foreground-side. The processor 130 may select a partition associated with the foreground-side as a candidate partition on a 3D view. The processor 130 may randomly select any one of the candidate partitions.

Referring to FIG. 10A, the processor 130 may search for (or select) a vertex P closest to a center point (0, 0) of a front end of a vehicle V_{ego} among four vertices of a source object 1000. The processor 130 may select two edges 1010 and 1020 that contact the found vertex P as the foreground-sides. Referring to FIG. 10B, the processor 130 may select six foreground-partitions associated with the selected foreground-sides as candidate partitions. The processor 130 may randomly select any one partition 1030 among the selected six candidate partitions.

In an operation S223, the processor 130 may determine whether there is a point in a partition of the target object that corresponds to the selected partition of the source object. Referring to FIG. 11, the processor 130 may determine whether there is a point in a partition 1130 of a target object 1100 that corresponds to the selected partition 1030 of the source object 1000.

When it is determined that there is the point in the partition of the target object, in an operation S224, the processor 130 may determine that it is valid to select the partition. On the other hand, when it is determined that there is no point in the partition of the target object, the processor 130 may determine that it is not valid to select the partition and may return to the operation S222 to select a partition again.

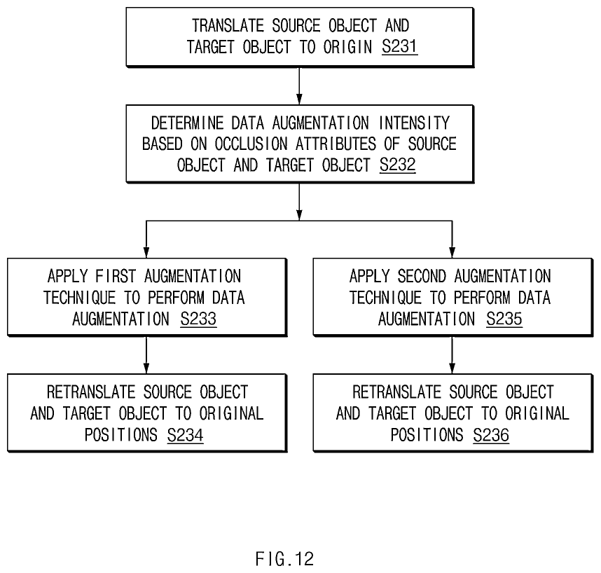

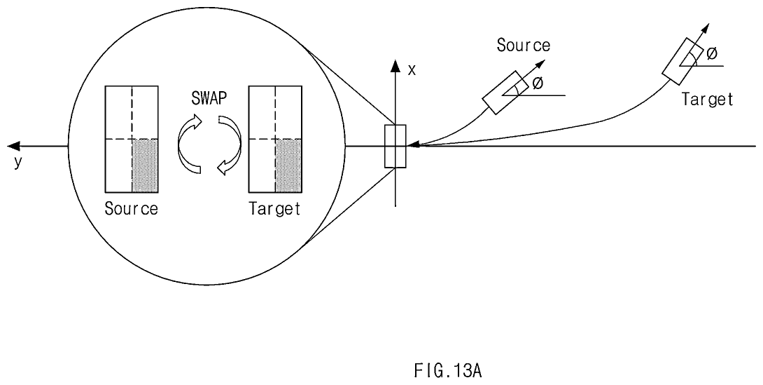

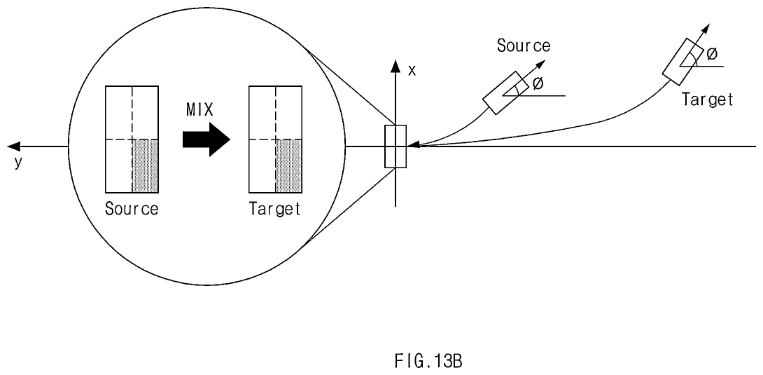

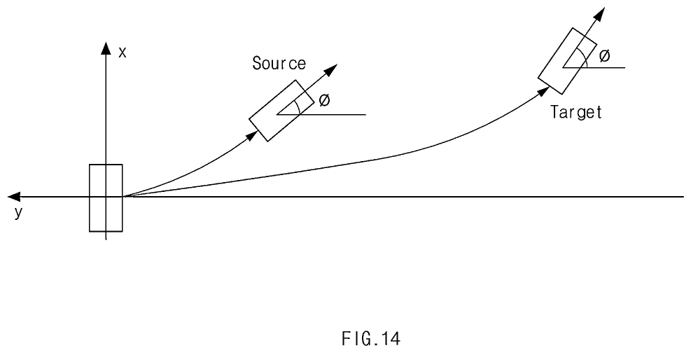

FIG. 12 is a flowchart illustrating a method for performing data augmentation shown in FIG. 3, according to embodiments of the present disclosure. FIG. 13A is drawing for describing a swap technique, according to embodiments of the present disclosure. FIG. 13B is drawing for describing a mix technique, according to embodiments of the present disclosure. FIG. 14 is drawing for describing object retranslation, according to embodiments of the present disclosure.

Referring to FIG. 12, in an operation S231, a processor (e.g., the processor 130) may translate a source object and a target object to the origin (0, 0). As shown in FIG. 13A, the processor 130 may translate the center of the source object to the origin, and may also translate the center of the target object to the origin.

In an operation S232, the processor 130 may determine data augmentation intensity based on occlusion attributes of the source object and the target object. The data augmentation intensity may be a probability that a first augmentation technique (e.g., a swap technique) and a second augmentation technique (e.g., a mix technique) will be applied to data augmentation, which may be determined as a value between “0” and “1”. When the data augmentation intensity is close to “1”, this may mean that the augmentation technique is applied at high intensity.

As an example, when the occlusion degree of the source object is “0” and the occlusion degree of the target object is “1”, the processor 130 may determine a probability that the first augmentation technique will be applied, e.g., a probability that data augmentation will be performed using the first augmentation technique, as “0.4”. Furthermore, when the occlusion degree of the source object is “0” and the occlusion degree of the target object is “2”, the processor 130 may determine the probability that the first augmentation technique will be applied as “0.2”. This may cause abnormal data not to be generated, when swapping points in partitions between objects with a similar occlusion degree.

As an example, when the occlusion degree of the source object is “0” and the occlusion degree of the target object is “1”, the processor 130 may determine a probability that the second augmentation technique will be applied (i.e., a probability that the second augmentation technique will proceed) as “0.5”. Furthermore, when the occlusion degree of the source object is “0” and the occlusion degree of the target object is “2”, the processor 130 may determine the probability that the second augmentation technique will be applied as “0.4”. Because the mix technique, i.e., the second augmentation technique, copies and pastes some points of the source object into the target object, although it is applied at a slightly higher probability than the swap technique which is the first augmentation technique for swapping points, there may be no burden on abnormal data.

In an operation S233, the processor 130 may apply the first augmentation technique to perform data augmentation for the source object and the target object. For example, the processor 130 may swap a point in the randomly selected partition of the source object for a point in a partition of the target object that corresponds to the randomly selected partition.

After performing the data augmentation using the first augmentation technique, in an operation S234, the processor 130 may retranslate the source object and the target object, that are moved, to original positions. For example, the processor 130 may retranslate the source object and the target object, that are moved, to positions of the source object and the target object before being moved.

In an operation S235, the processor 130 may apply the second augmentation technique to perform data augmentation for the source object and the target object. For example, the processor 130 may copy and paste a point in the randomly selected partition of the source object into a partition of the target object that corresponds to the randomly selected partition.

After performing the data augmentation using the second augmentation technique, in an operation S236, the processor 130 may retranslate the source object and the target object, that are moved, to the original positions. For example, the processor 130 may retranslate the source object and the target object, that are moved, to the positions of the source object and the target object before being moved.

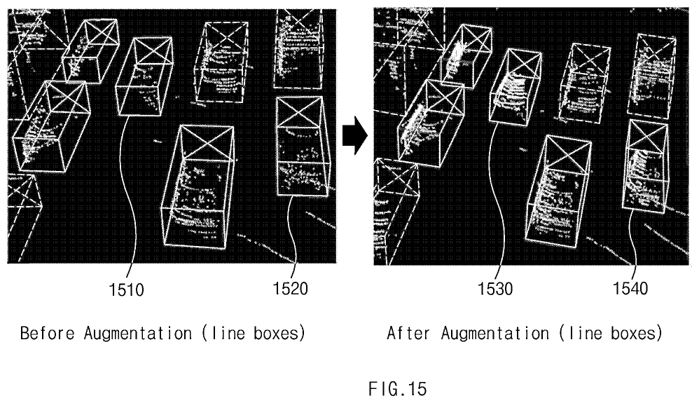

FIG. 15 is a drawing illustrating data before and after augmentation, according to embodiments of the present disclosure.

Referring to FIG. 15, a first object 1510 may have a sparse point configuration as a point in front of the first object 1510 is lost by occlusion due to a surrounding object, and a second object 1520 may have a sparse point configuration as it is located at a long distance.

After data augmentation for the object 1510 or 1520 using some points of another object which has a dense point configuration at a position similar to the object 1510 or 1520 is performed, it may be identified that point density of the augmented first object 1530 and point density of the augmented second object 1540 become high. It may be identified that the first object 1510 before being augmented changes to the object 1530 with the high point density and the second object 1520 before being augmented changes to the object 1540 with the high point density as right front points with respect to the front are reinforced.

Furthermore, upon augmenting point configurations which are not heterogeneous based on geometry information, the first object 1510 and the second object 1520 may change to data suitable for an object detection task.

As described above, the data augmentation technology according to embodiments of the present disclosure may change objects with a sparse point configuration to objects with a dense point configuration by means of data augmentation, thus compensating for the weakening of point density of the object, because the object is located at a long distance or due to occlusion by surrounding objects. Furthermore, the data augmentation technology according to embodiments of the present disclosure may augment a point based on geometry information between objects, thus augmenting a point configuration of the target object without the sense of difference when translating the point.

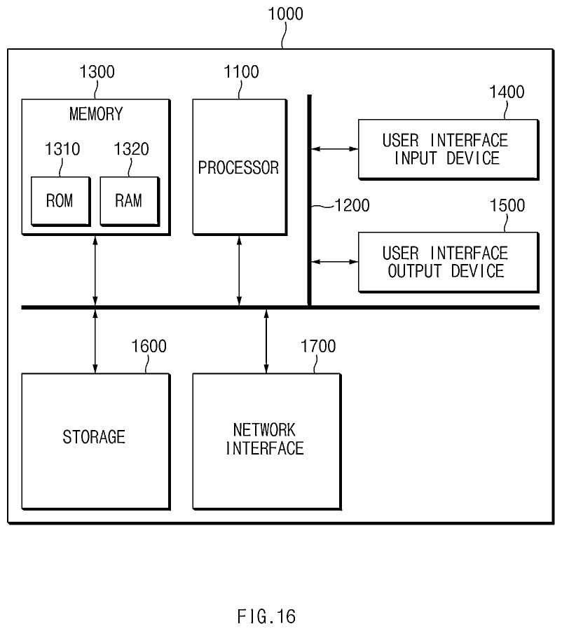

FIG. 16 is a block diagram illustrating a computing system for executing a data augmentation method, according to embodiments of the present disclosure.

Referring to FIG. 16, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm according to embodiments of the present disclosure may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

Embodiments of the present disclosure may improve learning performance through efficient data augmentation even for a dataset with high difficulty.

Embodiments of the present disclosure may be applied in only a training stage and is not applied in an inference stage on an application of the trained object detection network model, thus improving the performance of detection accuracy without affecting a time when the object detection network model is performed upon actual inference of the object detection network model.

Hereinabove, although the present disclosure has been described with reference to several embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An object detection apparatus, comprising:
a processor configured to
obtain point cloud data,
select a source object and a target object based on characteristics of multiple objects included in the point cloud data and geometry information between the multiple objects,
select a target partition to apply data augmentation based on geometry information between the source object and the target object,
perform data augmentation of the point cloud data by applying an augmentation technique to the target partition to generate augmented point cloud data, and
output the augmented point cloud data.

2. The object detection apparatus of claim 1, wherein the processor is configured to:
select the source object and the target object based on occlusion attributes of the multiple objects; and
determine effectiveness of selecting the source object and the target object based on the geometry information between the source object and the target object.

3. The object detection apparatus of claim 2, wherein the processor is configured to:
determine that it is valid to select the source object and the target object, when the source object and the target object are located in a same quadrant with respect to a vehicle and there are a heading of the source object and a heading of the target object at a same quadrantal angle.

4. The object detection apparatus of claim 1, wherein the processor is configured to:
segment each of the source object and the target object into a plurality of segmented partitions;
extract foreground-partitions of the source object among the segmented partitions of the source object;
randomly select a foreground-partition from among the foreground-partitions;
determine whether there is a point in a partition of the target object, the partition corresponding to the foreground-partition; and
determine that it is valid to select the foreground-partition based on determining that there is the point in the partition of the target object.

5. The object detection apparatus of claim 4, wherein the processor is configured to:
select a vertex closest to a vehicle among four vertices on a top view of the source object;
select an edge touching the vertex; and
select at least one partition associated with the edge as a candidate foreground-partition.

6. The object detection apparatus of claim 1, wherein the processor is configured to:
translate the source object and the target object to an origin;
determine data augmentation intensity based on occlusion attributes of the source object and the target object;
apply a first augmentation technique based on the data augmentation intensity to perform the data augmentation;
retranslate the source object and the target object augmented by the first augmentation technique to original positions;
apply a second augmentation technique based on the data augmentation intensity to perform the data augmentation; and
retranslate the source object and the target object augmented by the second augmentation technique to the original positions.

7. The object detection apparatus of claim 6, wherein the first augmentation technique is a swap technique for swapping a point in a randomly selected partition of the source object for a point in a partition of the target object, the partition corresponding to the randomly selected partition.

8. The object detection apparatus of claim 6, wherein the second augmentation technique is a mix technique for copying and pasting a point in a randomly selected partition of the source object into a partition of the target object, the partition corresponding to the randomly selected partition.

9. The object detection apparatus of claim 6, wherein the processor is configured to:
determine the data augmentation intensity based on a difference in occlusion degree between the source object and the target object.

10. The object detection apparatus of claim 1, wherein the processor is configured to:
train an object detection model using the augmented point cloud data.

11. A data augmentation method of an object detection apparatus, the data augmentation method comprising:
obtaining point cloud data;
selecting a source object and a target object based on characteristics of multiple objects included in the point cloud data and geometry information between the multiple objects;
selecting a target partition to apply data augmentation based on geometry information between the source object and the target object;
performing data augmentation of the point cloud data by applying an augmentation technique to the target partition to generate augmented point cloud data; and
outputting the augmented point cloud data.

12. The data augmentation method of claim 11, wherein selecting the source object and the target object includes:
selecting the source object and the target object with regard to occlusion attributes of the multiple objects; and
determining effectiveness of selecting the source object and the target object based on the geometry information between the source object and the target object.

13. The data augmentation method of claim 12, wherein determining the effectiveness includes:
determining that it is valid to select the source object and the target object when the source object and the target object are located in a same quadrant with respect to a vehicle and there are a heading of the source object and a heading of the target object at a same quadrantal angle.

14. The data augmentation method of claim 11, wherein selecting the target partition includes:
segmenting each of the source object and the target object into a plurality of segmented partitions;
extracting foreground-partitions of the source object among the segmented partitions of the source object;
randomly selecting a foreground-partition from among the foreground-partitions;
determining whether there is a point in a partition of the target object, the partition corresponding to the foreground-partition; and
determining that it is valid to select the foreground-partition, based on determining that there is the point in the partition of the target object.

15. The data augmentation method of claim 14, wherein extracting the foreground-partitions includes:
selecting a vertex closest to a vehicle among four vertices on a top view of the source object;
selecting an edge touching the vertex; and
selecting at least one partition associated with the edge as a candidate foreground-partition.

16. The data augmentation method of claim 11, wherein performing the data augmentation includes:
translating the source object and the target object to an origin;
determining data augmentation intensity based on occlusion attributes of the source object and the target object;
applying a first augmentation technique based on the data augmentation intensity to perform the data augmentation;
retranslating the source object and the target object augmented by the first augmentation technique to original positions;
applying a second augmentation technique based on the data augmentation intensity to perform the data augmentation; and
retranslating the source object and the target object augmented by the second augmentation technique to the original positions.

17. The data augmentation method of claim 16, wherein applying the first augmentation technique to perform the data augmentation includes:
swapping a point in a randomly selected partition of the source object for a point in a partition of the target object, the partition corresponding to the randomly selected partition.

18. The data augmentation method of claim 16, wherein applying the second augmentation technique to perform the data augmentation includes:
copying and pasting a point in a randomly selected partition of the source object into a partition of the target object, the partition corresponding to the randomly selected partition.

19. The data augmentation method of claim 16, wherein determining the data augmentation intensity includes:
determining the data augmentation intensity based on a difference in occlusion degree between the source object and the target object.

20. The data augmentation method of claim 11, further comprising:
training an object detection model using the augmented point cloud data.
